(19) United States
(12) Patent Application Publication
(10) Pub. No.: US 2016/0346807 A1
(43) Pub. Date: Dec. 1, 2016

(54) Apparatus for Maintaining a Quiescent Surface of a Fluid in a Container and Method of Operating

(71) Applicant: NIKE, Inc., Beaverton, OR (US)

(72) Inventors: Charles R. Edwards, Portland, OR (US); Lyle R. Hanson, Beaverton, OR (US)

(21) Appl. No.: 14/722,374

(22) Filed: May 27, 2015

(51) Int. Cl. B05D 5/06; B05D 7/00; B05D 1/18

(52) U.S. Cl. CPC B05D 5/06; B05D 1/18; B05D 7/00

(57) ABSTRACT

A system and process for maintaining a quiescent surface of a fluid in a fluid container is disclosed. A fluid container has a weir structure for capturing fluid when objects are dipped. The captured fluid is returned to the fluid container at a flow rate that maintains an essentially horizontal fluid surface, regardless of the volume of objects dipped.

### FIELD

The present embodiments relate generally to maintaining a quiescent surface of fluid in a container while objects are repeatedly immersed and removed from the container. In one embodiment, the apparatus relates to making a multicolored article, where portions are dipped in a colored dye solution to achieve different effects.

### BACKGROUND

Processes for dyeing articles are known in the art. Previous processes may have totally submerged an article in a single dip in a dye solution then stirred the article in the solution or circulated the solution to imbue the article with the color associated with the dye solution.

### BRIEF DESCRIPTION OF DRAWINGS

The embodiments can be better understood with reference to the following drawings and descriptions. The components in the figures are not necessarily to scale, emphasis instead being placed upon illustrating the principles of the embodiments. Moreover, in the figures, like reference numerals designate corresponding parts throughout the different views.

FIG. 1 is a schematic isometric view of an embodiment of a multicolored article.

FIG. 2 is an isometric view of an embodiment of a fluid container.

FIG. 3 is an isometric cutaway view of an embodiment of a fluid container with a weir structure.

FIG. 4 is a schematic view of an embodiment of a fluid container with an enlarged view of the fluid overflow and weir structure.

FIG. 5 is a schematic view of an embodiment of elements of an apparatus used to maintain a quiescent surface of fluid in a fluid container.

FIG. 6 is a schematic view of an embodiment of elements of an apparatus used to maintain a quiescent surface of fluid in a fluid container.

FIG. 7 is a schematic view of an embodiment of an element of an apparatus used to maintain a quiescent surface of fluid in a fluid container.

FIG. 8 is a schematic view of an embodiment of elements of an apparatus used to produce a colored article.

FIG. 9 is a schematic view of a general process used to produce a colored article.

FIGS. 10-13 are schematic views of an embodiment of elements of an apparatus used to produce a colored article.

FIG. 14 is a schematic view of an embodiment of elements of an apparatus used to produce a colored article.

FIG. 15 is a schematic view of a specific process used to maintain a quiescent surface of fluid in a fluid container.

FIG. 16 is a schematic view of an embodiment of elements of an apparatus used to produce a colored article while maintaining a quiescent surface of fluid in a fluid container.

### DESCRIPTION

Previous methods of dyeing often result in disturbances of the dye solution which introduce imperfections in the dyeing of the articles, such as dyeing of the articles in undesired locations due to splashing of the dye during the dyeing process. There exists a need for a more accurate dyeing process where an article, or a portion of an article, is dipped and removed several times into a dye solution while maintaining the surface of the dye solution at a substantially fixed horizontal level without any considerable disturbance on the surface.

In one aspect, the disclosure provides a method of operating a fluid container to maintain a quiescent surface when an object is lowered into fluid in the fluid container. The fluid container includes a container volume, a weir structure, and a lower portion. The volume of the object, or objects that are dipped, will be greater than the empty container volume in the fluid container. The fluid container allows fluid to overflow into the weir structure, thereby maintaining the fluid level in the fluid container. The method comprises of urging fluid to flow from a reservoir container to the lower portion of the fluid container at a flow rate of between about 125 percent of the container volume per minute and about 175 percent of the container volume per minute, and receiving overflow from the fluid container in the reservoir container.

The method of the present disclosure may further comprise the step of at least partially immersing the object into the fluid container while maintaining the flow rate of between about 125 percent of the container volume per minute and about 175 percent of the container volume per minute.

The method of the present disclosure may further comprise achieving an essentially constant first fluid level above the weir structure in the fluid container when immersing the object into the fluid container.

The method of the present disclosure may further comprise achieving an essentially constant second fluid level above the weir structure in the fluid container when the object is immersed in the fluid container and when the object is fully removed from the fluid container.

The method of the present disclosure may further comprise ducting the flow from the reservoir to the fluid container.

The method of the present disclosure may further comprise again immersing the object. The second immersion may be within between about 10 seconds and about 60 seconds of the first immersion. When an essentially constant second fluid level is achieved, the essentially constant fluid level may be achieved within about 5-20 percent of the time between the second immersion and the first immersion.

The method of the present disclosure may further comprise a step of measuring a height of the fluid flowing over the weir structure.

The method of the present disclosure may further comprise a step of controlling the depth of the immersion of the object.

The method of the present disclosure may further comprise a step of comparing the height of the fluid flowing over the weir structure to the second fluid level to control the depth of immersion of the object.

The method of the present disclosure may be a method wherein the object has an object volume; and the object volume is up to about 8 percent of the container volume.

The method of the present disclosure may be a method wherein a refill rate of the fluid container is between about 125 percent of the container volume per minute and about 325 percent of the container volume per minute.

The method of the present disclosure may be a method wherein the container volume returned by the refill rate is between about 10 percent and about 50 percent of the container volume during a set period. The set period may be within between about 5 seconds and 10 seconds.

The method of the present disclosure may be a method of dyeing an object, comprising operating the fluid container of the present disclosure, wherein the fluid comprises a dye solution, and further comprising the steps of placing the fluid comprising the dye solution in the fluid container, lowering the object to be dyed at least partially into the fluid, maintaining the quiescent surface when the object to be dyed is lowered into the fluid comprising the dye solution in the fluid container, allowing dye from the fluid to contact and dye the object, producing a dyed object, and subsequently removing the dyed object from the fluid. The method of dyeing an object may be a method wherein a first pre-determined portion of the object is to be dyed and a second predetermined portion of the object is to be left undyed, comprising lowering the object into the fluid to a pre-determined level, thereby dyeing the first predetermined portion of the object and leaving the majority of the second predetermined portion of the object undyed. The method of dyeing may be a method wherein the method reduces the amount of splashed fluid which contacts the object within the second predetermined portion which is to be left undyed when the object is lowered into the fluid as compared to use of an identical method except using a fluid container without the weir structure, and without urging the fluid to flow from a reservoir container to the lower portion of the fluid container at a flow rate of between about 125 percent of the container volume per minute and about 175 percent of the container volume per minute.

The method of the present disclosure may be a method wherein the object is buoyant in the fluid. The buoyant object may be a fluid-filled bladder configured for use as a cushioning element of an article of footwear.

Other systems, methods, features and advantages of the embodiments will be, or will become, apparent to one of ordinary skill in the art upon examination of the following figures and detailed description. It is intended that all such additional systems, methods, features and advantages be included within this description and this summary, be within the scope of the embodiments, and be protected by the following claims.

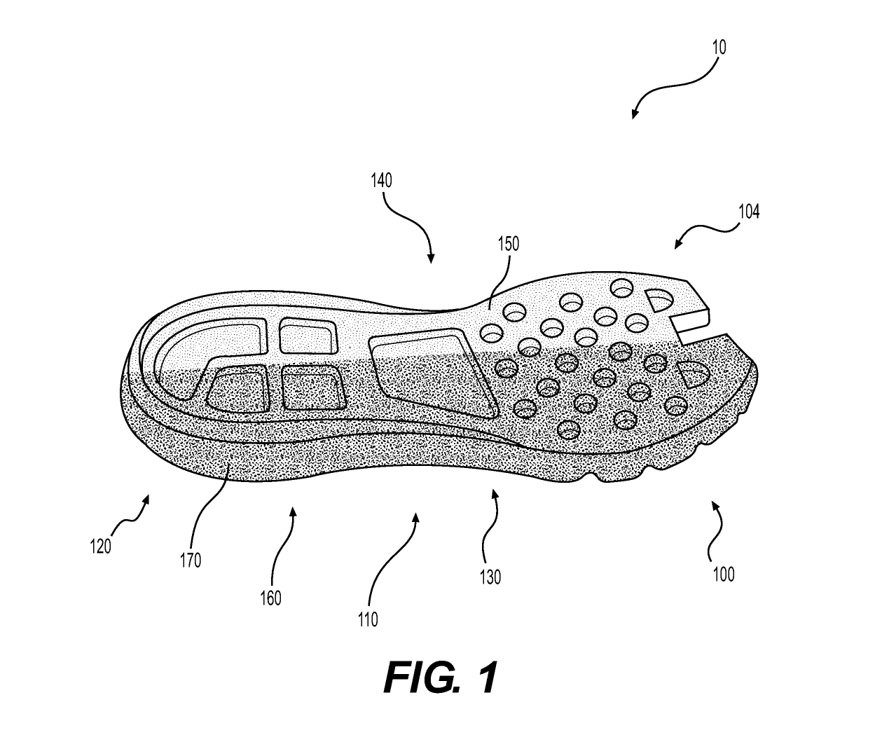

FIG. 1 illustrates a schematic isometric view of an embodiment of a multicolored object or multicolored article 10. In some embodiments, article 10 may comprise of a bladder member or airbag that may be incorporated into an article of footwear. In some other embodiments, article 10 may be further attached to additional components of a sole system including an outsole, midsole, and/or insole. In an exemplary embodiment, article 10 may be a bladder for a sole system of an article of footwear.

For consistency and convenience, directional adjectives are employed throughout this detailed description corresponding to the illustrated embodiments. The term “longitudinal” as used throughout this detailed description and in the claims may refer to a direction extending a length of the footwear. In some cases, the longitudinal direction may extend from a forefoot region to a heel region of the article of footwear. Also, the term “lateral” as used throughout this detailed description and in the claims may refer to a direction extending along a width of the article of footwear. In other words, the lateral direction may extend between a lateral side and a medial side of the article of footwear.

For purposes of illustration, FIG. 1 shows article 10 in isolation from other components of footwear. However, it will be understood that article 10 may be utilized in various different kinds of footwear including, but not limited to: hiking boots, soccer shoes, football shoes, sneakers, running shoes, cross-training shoes, rugby shoes, basketball shoes, and baseball shoes, as well as other kinds of shoes. Moreover, in some embodiments, article 10 may be configured for use with various kinds of non-sports related footwear, including, but not limited to: slippers, sandals, high-heeled footwear, and loafers, as well as other kinds of footwear.

Article 10 may be divided into forefoot portion 100, midfoot portion 110, and heel portion 120. As shown article 10 may be associated with the right foot; however it should be understood that the following discussion may equally apply to a mirror image of article 10 that is intended for use with a left foot. Forefoot portion 100 may generally be associated with the toes and joints connecting the metatarsals with the phalanges. In some embodiments, forefoot portion 100 may include toe portion 104. Midfoot portion 110 may be generally associated with the arch of a foot. Likewise, heel portion 120 may be generally associated with the heel of a foot, including the calcaneus bone.

In some embodiments, article 10 may include a lateral side and a medial side. Lateral side 130 may be associated with the outside parts of a foot. Medial side 140 may be associated with the inside parts of a foot. In particular, lateral side 130 and medial side 140 may be opposing sides of article 10. Furthermore, lateral side 130 and medial side 140 may extend through forefoot portion 100, midfoot portion 110, and heel portion 120.

It will be understood that forefoot portion 100, midfoot portion 110, and heel portion 120 are only intended for purpose of description and are not intended to demarcate precise regions of article 10. Likewise lateral side 130 and medial side 140 are intended to represent generally two sides rather than precisely demarcating article 10 into two halves.

In some embodiments, article 10 may include a first or upper surface 150. In some embodiments, article may include a second or lower surface 160 disposed opposite upper surface 150. In some embodiments, article 10 may further include a third or peripheral surface 170 disposed between upper surface 150 and lower surface 160. In some embodiments, upper surface 150, lower surface 160, and peripheral surface 170 may be joined to form and enclose an interior cavity.

In some embodiments, the interior cavity may be filled with a fluid, including liquid or gas. In some embodiments, upper surface 150, lower surface 160, and peripheral surface 170 may be substantially impermeable to the fluid. In an exemplary embodiment, the interior cavity is filled with gas thereby allowing article 10 to act as a cushioning element to increase the comfort, flexibility, and support of a sole system for footwear. In other embodiments, the interior cavity may be filled with a gel.

Some embodiments of article 10 may have a multicolored design, pattern, or visual appearance wherein different portions of article 10 have different colors. In some embodiments, a sole system may include article 10 where a transition area or overlay is visible between two or more different portions having two or more different colors imbued on surfaces of article 10. In one embodiment, the transition between two colors may occur longitudinally in midfoot portion 110. In another embodiment, the transition area may be omitted and instead a distinct line between two or more colors occurs laterally in the forefoot portion 100, midfoot portion 110, and heel portion 120, as illustrated in FIG. 1. In still some other embodiments, article 10 may be colored along peripheral surface 170.

For purposes of illustration, FIG. 1 in this detailed description makes use of different shading, or stippling to indicate exemplary variations in color of article 10. Thus, for example, portions or regions of similar shading/stippling may be associated with a common color. Likewise, portions or regions with different shading/stippling may be associated with a different color. In addition, figures in this detailed description make use of enlarged views to further clarify the embodiments.

Some embodiments may include provisions to color an article by a dipping process. As used in this detailed description and in the claims, dipping process and its variants thereof, may comprise of taking an article and successively dipping portions of the article into and out of a dye solution, thus imbuing the article with a color. In some embodiments, the dipping process may be achieved using an apparatus comprised of various components. These components and the dipping process will be explained further in detail below.

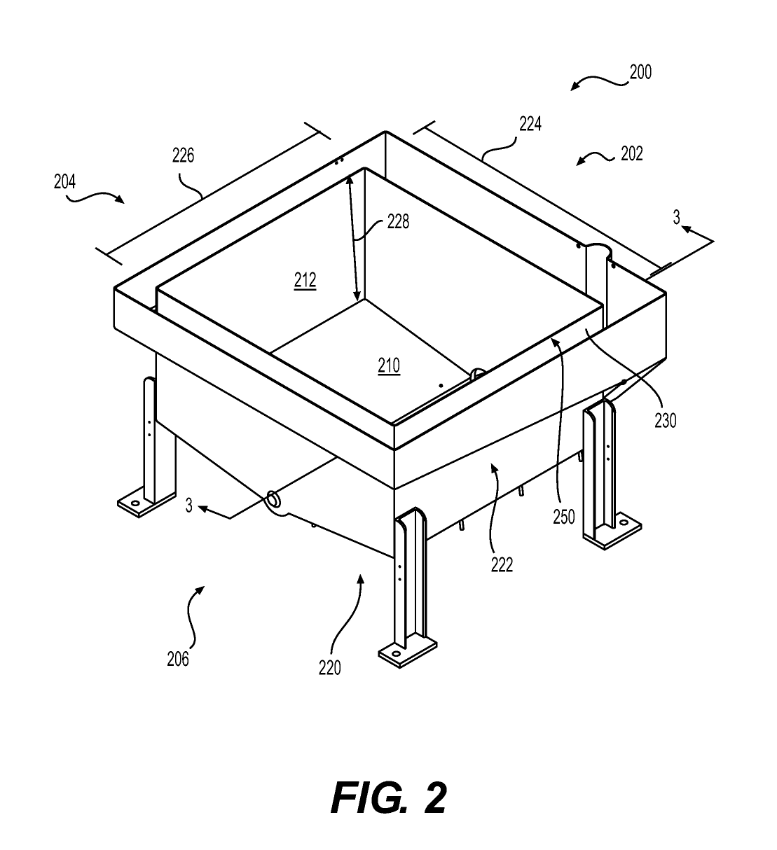

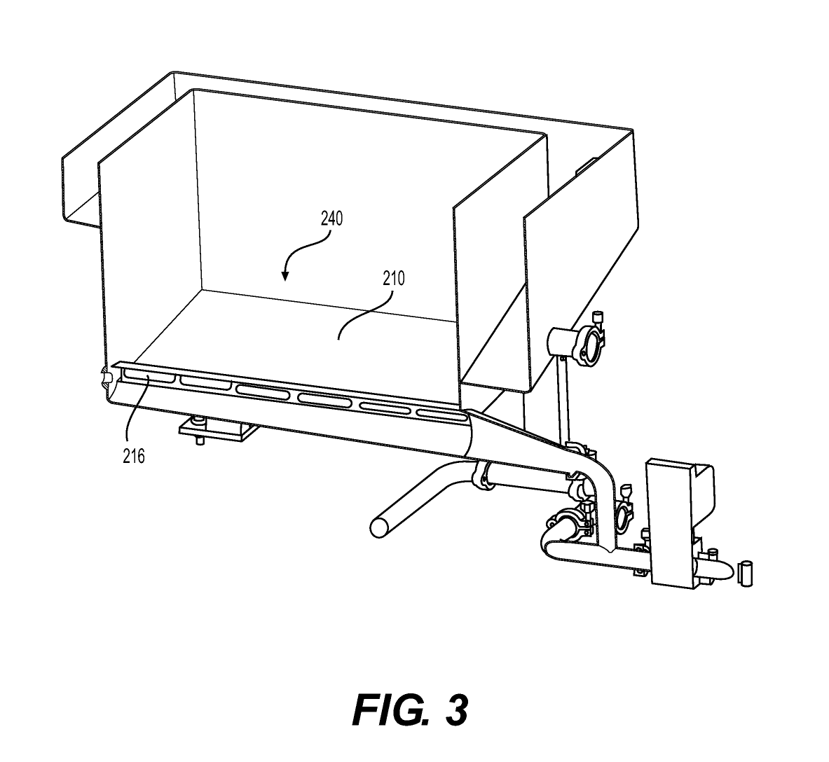

FIGS. 2 and 3 illustrate an exemplary embodiment of a fluid container that may be used for the process of dipping article 10. In some embodiments, fluid container 200 may include an opening 202 located at first end 204. In some embodiments, fluid container 200 may include interior lower surface or lower portion 210, located at second end 206. In some embodiments, fluid container 200 may further include interior side portion or surface 212, exterior lower portion or surface 220, and exterior side portion or surface 222.

In some embodiments, fluid container 200 may include provisions to transport fluid through interior lower portion 210. In some embodiments, interior lower portion 210 may include apertures 216. In some embodiments, apertures 216 may be used as a fluid outlet to refill fluid container 200 with fluid from a fluid reservoir container. Apertures 216 may be so dimensioned and spaced by those skilled in the art to enable passage of fluid at controlled rate of flow from the fluid reservoir container. In alternative embodiments, a diffuser plate with apertures may be used to transport fluid through interior lower portion 210.

In some embodiments, fluid container 200 may be so dimensioned and sized by those skilled in the art to enable fluid container 200 to receive objects. In some embodiments, fluid container 200 may have various geometries. In some embodiments, fluid container 200 may have a substantially rectangular prismatic geometry with a fluid container width, a fluid container height or depth, and a fluid container length. In some embodiments, a fluid container may have a container volume defined by the surfaces of fluid container 200. In one embodiment, fluid container 200 has fluid container volume 250 bounded by fluid container width 224, fluid container length 226, and fluid container height or depth 228.

Fluid container 200 may be configured for receiving and retaining fluid. In some embodiments, fluid may be a dye solution associated with a color. In some embodiments, fluid container 200 may further include provisions for handling fluid that may spill over the sides of fluid container 200 as objects are dipped into the fluid. In some embodiments, fluid container 200 may include an overflow weir structure. In an exemplary embodiment, overflow weir structure 230 enables fluid container 200 to capture fluid spilling out of opening 202 at first end 204, without spilling over the exterior side surface 222 of fluid container 200. In some embodiments, weir structure 230 may allow fluid container 200 to maintain a level of fluid at a fixed height regardless of the volume of objects dipped into the fluid in fluid container 200. The process of maintaining a level of fluid at a fixed height relative to overflow structure 230 will be explained further in detail below.

Referring to FIG. 3, which is a section view taken along line 3-3 in FIG. 2, fluid container 200 may include other components for use in facilitating the dipping and coloring process. In some embodiments, fluid container 200 may include provisions for heating the fluid. As shown in the cut away figure, in some embodiments, lower portion 210 may include plate heaters 240. Plate heaters 240 may be used to heat the fluid in fluid container 200 to a desired temperature or temperature range without deforming objects dipped into and out of fluid container 200. In one embodiment, the fluid may be heated to a temperature range between about 20 degrees Celsius and about 80 degrees Celsius, typically between about 25 degrees Celsius and about 70 degrees Celsius.

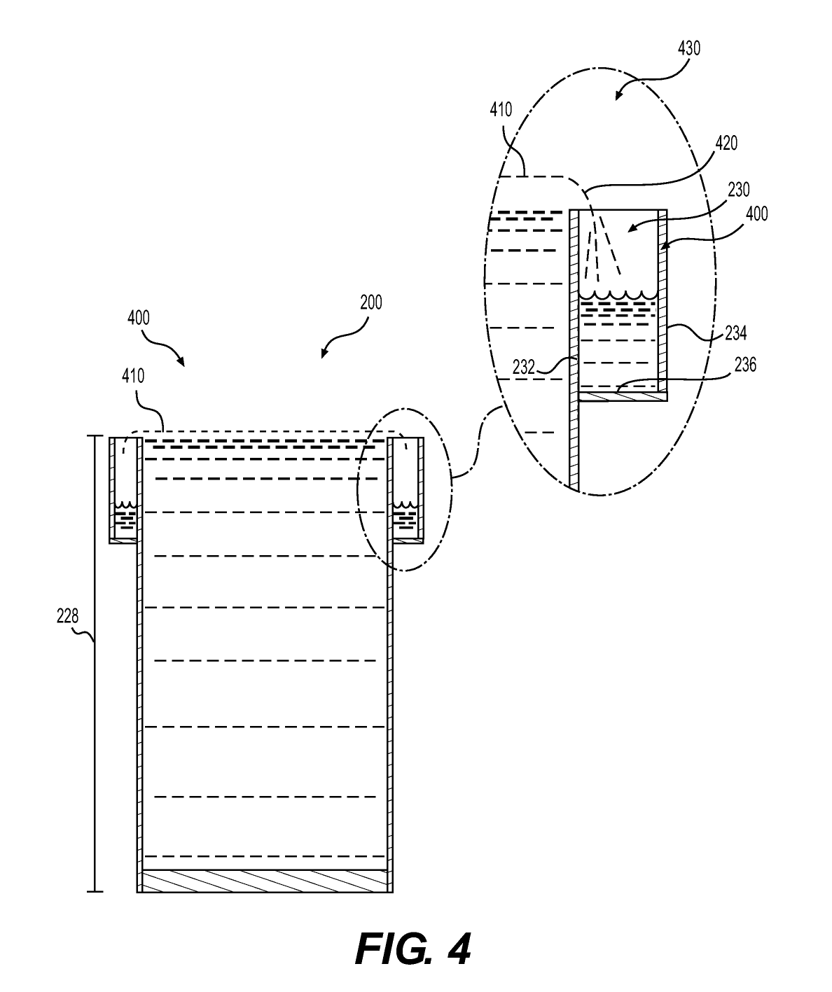

Referring to FIG. 4, a schematic view of fluid container 200 having weir structure 230 to handle an overflow of a fluid is illustrated. In some embodiments, as objects or articles of sufficient volume (not shown) are immersed into fluid 400 in fluid container 200, during an embodiment of a dipping process, fluid level 410 may rise to a fluid height due to displacement of a volume of fluid 400. In some embodiments, fluid height 430 may be greater than fluid container height 228 thus causing fluid level 410 to rise above weir structure 230. In some embodiments, as fluid level 410 rises above fluid container height 228, fluid 400 may spill over weir structure 230 as overflow 420, shown for example in the enlarged view of FIG. 4.

Weir structure 230 may be so sized and dimensioned by those skilled in the art so that overflow 420 can be received without overflowing over fluid container 200. In some embodiments, weir structure 230 may include weir basin or channel 236 formed by weir front face 232 and weir rear face 234. In some embodiments, overflow 420 flows into weir channel 236 and is transported into a fluid reservoir container (not shown) for recirculation into fluid container 200. It is to be understood that although weir front face 232, weir rear face 234, and weir basin 236 are depicted in two-dimensions in FIG. 4, all three elements extend around a perimeter of opening 202 of fluid container 200, as shown in FIG. 2.

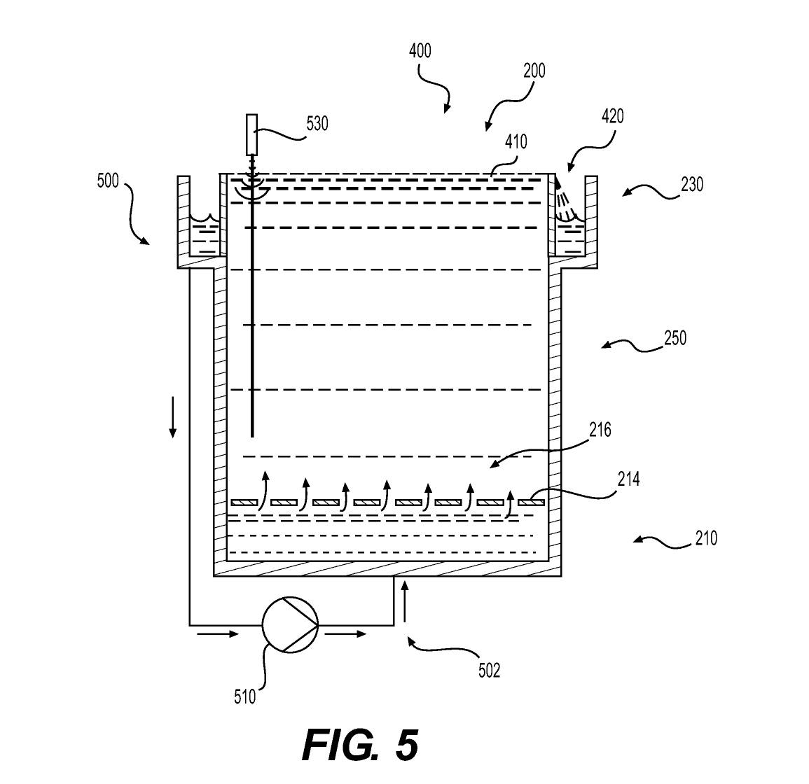

FIG. 5 illustrates a schematic view of an exemplary process of maintaining a level of a fluid at a fixed height and capturing an overflow of the fluid for recirculation back into the process. In some embodiments, maintaining a level of fluid at a fixed or constant height during operation results in fluid having a quiescent surface. As used in this detailed description and in the claims, a quiescent surface may be characterized as the surface of fluid in a container, wherein the surface is substantially horizontal essentially without any disturbances or perturbations as other elements or fluids are introduced. In some embodiments, maintaining a quiescent surface of a fluid has a variety of uses by those skilled in the art. In this exemplary embodiment, the quiescent surface is maintained to achieve a coloring process on an article as the article is lowered into and raised from a dye solution.

In some embodiments, the coloring process of dipping objects into and out a dye solution in fluid container 200 several times in order to imbue a color on objects may be achieved by maintaining fluid level 410 at a known fixed height relative to weir structure 230. In some embodiments, the known fixed height relative to weir structure 230 may be required as objects are immersed to a desired fluid penetration depth. As used in this detailed description and in the claims, fluid penetration depth and its variants thereof, may be characterized as the depth needed for an article to be immersed into fluid container 200, with fluid such as a dye solution, to achieve coloring a desired surface area of the article with the fluid. In one embodiment, fluid penetration depth for an article may range from 0.01 inches to about 20 inches, typically from 0.05 inches to about 15 inches. In some other embodiments, the fluid penetration depth may be different.

As shown in the schematic diagram of FIG. 5, as overflow 420 flows into weir structure 230 it is conveyed to fluid reservoir container 500. Subsequently, fluid 400 is recirculated back into fluid container 200. In one embodiment, fluid 400 is recirculated through plate 214 with plate apertures 216 disposed on interior lower portion 210. In some embodiments, the reintroduction of fluid 400 into fluid container 200 from fluid reservoir container 500 is achieved through the use of a pump. In some embodiments, the pump may be any pump known in the art for pumping a fluid at a controlled rate. In some embodiments, the pump may be a peristaltic pump. In another embodiment, pump may be a ducted vertical axial flow pump. In an exemplary embodiment, pump 510 is a centrifugal pump, for use in moving flow or flow rate 502 from fluid reservoir container 500 to fluid container 200. Pump 510 may be sized and dimensioned by those skilled in the art based on a desired flow rate of fluid.

In some embodiments, flow rate 502 of fluid 400 may vary to maintain the fluid level at a fixed height above the weir structure. In some embodiments, flow rate 502 may range between different percentages of fluid container volume 250. In an exemplary embodiment, during the dipping process flow rate 502 may be between at least 125 percent and at least 175 percent per minute of fluid container volume 250. In some other embodiments, flow rate 502 may be between different percentages.

In some embodiments, by introducing fluid 400 to fluid container 200 at a known controlled flow rate, while dipping objects into and out of fluid container, a consistent level of displacement of fluid 400 may be achieved. Accordingly, fluid level 410 may always be at a known height relative to weir structure 230 as objects are immersed to a certain fluid penetration depth.

Some embodiments may include provisions for determining the fluid level 410 at a height relative to weir structure 230 during operation. In some embodiments, various sensors known in the art for measuring fluid height or levels in a container may be utilized. In an exemplary embodiment, sensor 530 is used to measure fluid height 430 as objects are immersed into the fluid and subsequently removed.

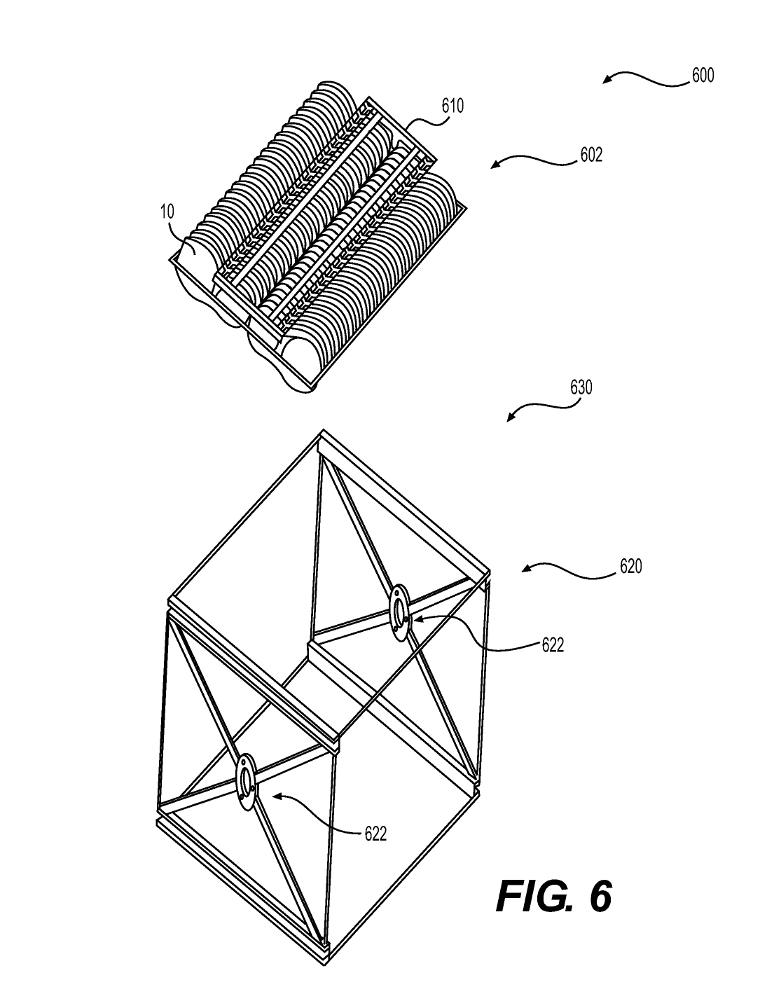

Referring to FIG. 6, some embodiments may include provisions for facilitating the dipping of objects into and out of fluid container 200 during operation. In some embodiments, objects such as article 10 may be dipped using rack carrying assembly 600. In some embodiments, rack carrying assembly 600 may include article carrying member 610. Article carrying member 610 may be so dimensioned and sized by those skilled in the art for holding and securing article 10 or multiple articles 602 for dipping. Article 10 placed in article carrying member 610 may be securely fastened so as to not move while being immersed into and out of fluid container 200. In an exemplary embodiment, article carrying member 610 can secure forty pairs of article 10 for dipping.

In some embodiments, article carrying member 610 may receive and secure articles 602 so that articles 602 are oriented properly for dipping into fluid container 200. In one example, articles 602 are secured in article carrying member 610 such that their lateral side is oriented for dipping into fluid container 200. In still some other embodiments, article carrying member 610 may secure articles 602 so that articles 602 are oriented in alternative ways for dipping into fluid container 200.

In some embodiments, rack carrying assembly 600 may further include rack basket member 620. In some embodiments, rack basket member 620 may hold articles 602 in any configuration that does not interfere with dyeing. In some embodiments, rack basket member 620 may include securing apertures 622. In one embodiment, securing apertures 622 may be used to facilitate the rotation of article 10 and article carrying member 610. In some embodiments, rack basket member 620 may be rotated so that articles 602 (loaded onto article carrying member 610) are oriented in a certain way for dipping which will be explained further in detail below.

In some embodiments, rack carrying assembly 600 may have an object volume or rack volume. As used in this detailed description and in the claims, rack volume and its variants thereof may refer to the volume of rack carrying assembly 600 and articles 602. When rack carrying assembly 600 is dipped into fluid container 200, the rack volume may reduce the volume of fluid 400 in fluid container 200 due to the displacement of fluid 400. In some embodiments, rack volume 630 may be proportional to fluid container volume 250. In one embodiment, rack volume 630 is approximately 8 percent of fluid container volume 250. In some other embodiments, rack volume 630 may have a greater proportion of tank volume. In still some other embodiments, rack volume 630 may have a lesser value.

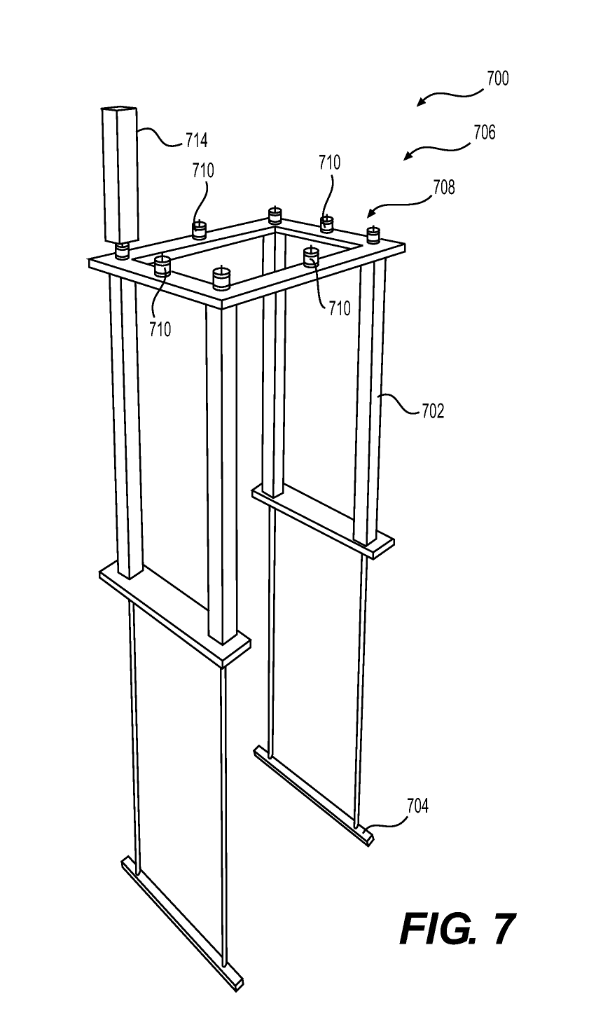

Referring to FIG. 7, some embodiments may include provisions for positioning rack carrying assembly 600. In particular, some embodiments may have components for lowering and raising rack carrying assembly 600 with respect to fluid container 200 during operation. In one embodiment, actuator 700 may be used to dip rack carrying assembly 600 into and out of fluid container 200. In some embodiments, actuator 700 may comprise of a plurality of linear actuators 702. In some embodiments, actuator 700 may further comprise of rack clamp 704 for securing rack carrying assembly 600.

In some embodiments, actuator 700 may include an actuator pulley arrangement 706. In some embodiments actuator pulley arrangement 706 includes a plurality of pulleys 708. For purposes of illustration, the pulleys are shown in isolation without any belt systems. In some embodiments, pulleys 708 may include idler pulleys 710. In some other embodiments, actuator 700 may be configured to operate using any motor known in the art. In an exemplary embodiment, actuator 700 may utilize servo motor 714 during operation. In still some other embodiments, actuator 700 may be operated manually.

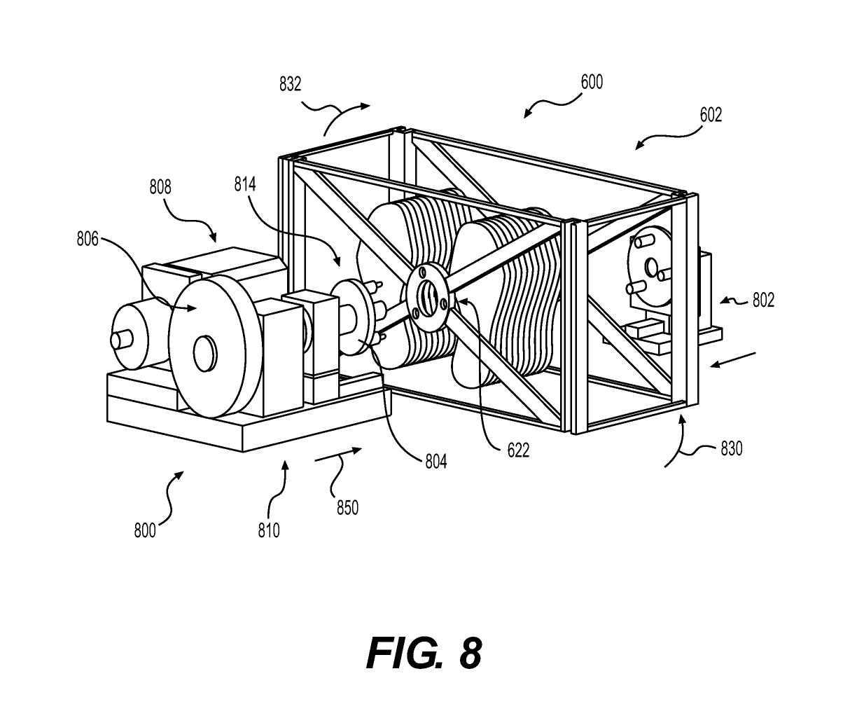

Some embodiments may include provisions for rotating rack carrying assembly 600. The ability to rotate rack carrying assembly 600 enables alternative surface areas or regions on articles 602 to be inserted into fluid container 200 regardless of how articles 602 may be initially loaded and placed in an article carrying member. In some embodiments, rack carrying assembly 600 is rotated by rack rotating assembly 800 as shown in FIG. 8. In some embodiments, rack rotating assembly 800 may be used to rotate rack carrying assembly 600 either in first rotational direction 830 or second rotational direction 832. In still some other embodiments, second rack rotating assembly 802 may be utilized. In some embodiments, rack rotating assembly 800 may comprise of various components. In one embodiment, rack rotating assembly 800 comprises of engagement tooling member 804, rack rotating pulley arrangement 806, motor 808, and actuator shuttle 810. Each of these components will be discussed further in detail below.

In some embodiments, rack rotating assembly 800 may include engagement tooling member 804. Engagement tooling member 804 may be used to secure rack carrying assembly 600 for rotation. In particular, engagement tooling member 804 may include one or more securing elements 814. Securing elements 814 may be so dimensioned and sized by those skilled in the art such that securing elements 814 may be inserted into securing apertures 622 on rack basket member 620.

In some embodiments, rack rotating assembly 800 may include rack rotating pulley arrangement 806. Rack rotating pulley arrangement 806 may be any pulley system known in the art for use in actuating engagement tooling member 804. In some embodiments, rack rotating pulley arrangement 806 may be coupled with a belt system (not shown). In some embodiments, rack rotating pulley arrangement 806 may be coupled with a motor system to support the rotation of rack carrying assembly 600.

In some embodiments, rack rotating assembly 800 may include motor 808. Motor 808 may be any motorized system known in the art to power rack rotating assembly 800. In some embodiments, motor 808 may be used to engage pulley arrangement 808 to convey, move, or actuate other elements of rack rotating assembly 800. In an exemplary embodiment, motor 808 is a stepper motor.

In some embodiments, rack rotating assembly 800 may include actuator shuttle 810. Actuator shuttle 810 may be any type of mechanism known in the art capable of moving or actuating 850 elements of rack rotating assembly 800 to engage rack carrying assembly 600. In an exemplary embodiment, actuator shuttle 810 is a pneumatically actuated shuttle.

Rack rotating assembly 800 may include other elements, such as shafts, gears, ropes and cables which are known in the art and can be used in facilitating the rotation of rack carrying assembly 602.

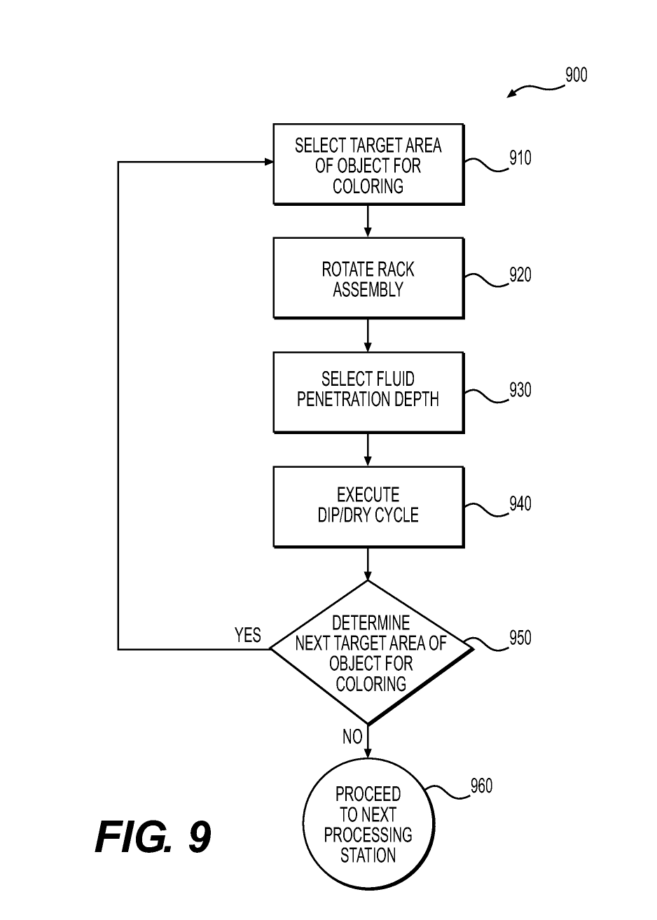

FIG. 9 illustrates a diagram for general dipping process 900 for immersing and removing an article or multiple articles into and out of a fluid container. The fluid container includes a fluid at a certain height or level above a weir structure for maintaining a quiescent surface. For clarity, the following detailed description discusses an exemplary embodiment of dipping process 900 in which a target area on article is selected for coloring, the article is oriented to facilitate coloring of target area, and the article is dipped into a dye solution thereby contacting the article and dye or color the target area. As used in this detailed description and in the claims, target area and its variants thereof may be characterized as a specific pre-determined portion, region or area of an article, designated for dipping into and out of fluid in a fluid container. In an exemplary embodiment, target area may be defined as the pre-determined portion, region, or area of an article selected for immersing in a dye solution for coloring.

In some embodiments, some of the following steps may be controlled by a control unit associated with dipping process 900. In some other embodiments, these steps may be performed by additional systems or devices associated with dipping process 900. For example, for dipping process 900 having sensors or devices for measuring various parameters, one or more steps may be performed by the sensors or devices. In addition, in embodiments where dipping process 900 is in electronic communication with a computer (not shown), one or more steps may be performed by the computer. In addition it will be understood that in other embodiments, one or more of the following steps may be optional.

As illustrated in FIG. 9, during dipping process 900, article 10 may be dipped repeatedly into fluid container 200 in a series of cycles thereby coloring the article. Articles which are repeatedly dipped into and out of a dye solution for coloring are described in Edwards, U.S. Patent Publication Number 20140250735, published on Sep. 11, 2014, and titled “Method of Making Multi-Colored Objects” (referred to hereafter as “'735 application”), which is herein incorporated by reference. In some embodiments, these cycles where article 10 is repeatedly immersed and then removed from fluid container having fluid (e.g. dye solution) may be associated with a dip/dry cycle. As described in the '735 application, dip/dry cycle may be characterized as the cycle of one dip into a dye solution and removal for a drying period. In some embodiments, this cycle may be repeated in a series to imbue the article with a selected color and hue saturation.

During Step 910, a target area on article 10 is determined for coloring. In some embodiments, target area may be located on any surface of article 10. In some embodiments, the target area may be lateral side 130 of article 10. In some other embodiments, the target area may be on peripheral surface 170. In an exemplary embodiment, toe portion 104 of article 10 is selected for the target area.

In Step 920, as rack carrying assembly 600 is positioned for immersion, in some embodiments, article 10 may need to be rotated in order to orient the target area on article 10 for dipping. As described above, in some embodiments, rotation of article 10 in rack carrying assembly 600 is accomplished by rack rotating assembly 800.

Following Step 920, in Step 930 a fluid penetration depth is selected. As described above, fluid penetration depth is characterized as the depth needed for an article to be immersed into fluid container 200 having fluid 400 in order to achieve coloring of a desired target area of article 10 with dye solution. For a given fluid penetration depth selected, fluid level 410 must be maintained at a constant height relative to weir 230 as article 10 is immersed. In some embodiments, fluid penetration depth may immerse entire article 10 in dye solution thereby producing a dyed object. In some other embodiments, fluid penetration depth may immerse only a portion of article 10 to produce a dyed object.

Following Step 930, in Step 940, the dip/dry cycle is executed. As previously described above, to properly maintain a quiescent surface during operation, fluid level 410 having a constant fluid height relative to weir structure 230 is required. Without a constant fluid level 410, the fluid penetration depth for target area of article 10 may not be accurate resulting in an uneven concentration of dye solution on a target area of article 10.

During Step 940, as article 10 is immersed into and out of fluid container 200, pump 500 maintains flow rate 502 as previously mentioned above. As article 10 is lowered into fluid container 200, flow rate 502 may increase and fluid level 410 may rise while the dye solution is displaced. The displacement of dye solution and increase in flow rate 502 results in increased overflow 420 flowing over weir structure 230 and into fluid reservoir container 500. As article 10 is raised from fluid container 200, flow rate 502 decreases and is adjusted to maintain constant fluid level 410 for a subsequent dip/dry cycle. The actions taking place during Step 940 will further be explained in detail below.

After Step 940, in Step 950, a decision is made as to whether a next target area is to be selected. In some embodiments, the same target area of article 10 may be repeatedly immersed and then removed until the desired saturation level and color hue is imbued on target area. In some embodiments, a different target area on article 10 may be selected. For example, the first target area may be forefoot portion 100 of article 10, and the second target area may be midfoot portion 110. Accordingly, the dipping process may revert back to step 910 to repeat the cycle for the second target area.

It is understood that during step 940 and the execution of the dip/dry cycle, only the specific pre-determined portion or target area of the object is to be dyed. Therefore, if the forefoot portion 100 is the first pre-determined target area, and the midfoot portion 110 is the second pre-determined target area, only the forefoot portion 100 will be dyed during that specific dip/dry cycle, and the midfoot portion 110 will be undyed.

Finally in Step 960, once the desired target areas of article 10 have achieved the desired saturation level of color, article 10 is removed from the fluid in fluid container 200 and proceeds to the next processing station. In some embodiments, multiple processing stations may include other containers for immersing article 10. In some embodiments, besides fluid container 200 having a first dye solution related to a first color, other processing stations may include a second fluid container having a second dye solution related to a second color. In some other embodiments, a third processing station may be provided and include a third fluid container for washing article 10. In still some other embodiments, a fourth processing station may be provided and include a fourth container for rinsing article 10. In still another embodiment, a fifth processing station may be provided and which may include further rotating article 10. It is understood that these processing stations are not listed to convey a particular order or sequence and that one processing station may be before or after another processing station according to different embodiments. Further, it is understood that not all processing stations require a constant fluid level 410 or quiescent surface and therefore components located in one processing station may be optional in a different processing station.

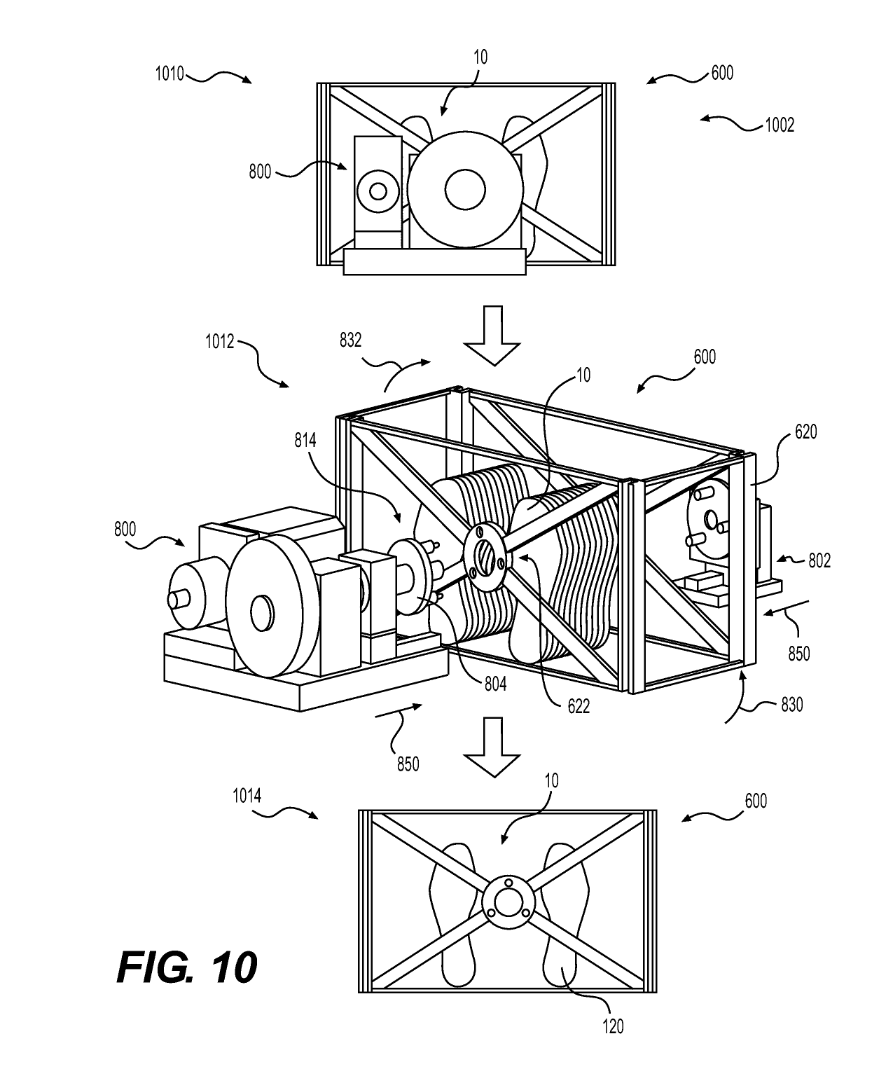

FIGS. 10 through 14 illustrate alternative embodiments where rack carrying assembly 600 is rotated by rack rotating assembly 800 to position and orient rack carrying assembly 600. Each of FIGS. 10 through 14 depict an exemplary sequence of configurations where it may be necessary to rotate rack carrying assembly 600 along first rotational direction 830 or second rotational direction 832. As previously mentioned above, rotation along first rotational direction 830 or second rotational direction 832 may be required when, for example, multiple target areas on article 10 have been selected to be colored with a dye solution.

FIG. 10 illustrates a schematic sequential view of article 10 undergoing rotation in order to orient heel portion 120, the selected target area, for dipping. Rack carrying assembly 600 may be conveyed or moved by means known in the art to processing station 1002. As mentioned previously, in some embodiments, processing station 1002 may be a station where an action may be taken on article 10 such as washing, rinsing, or dyeing. In this exemplary embodiment, processing station 1002 will rotate rack carrying assembly 600 to orient article 10 in the desired direction prior to immersion in a fluid. In first configuration 1010, as rack carrying assembly 600 is positioned at processing station 1002, rack rotating assembly 800 and second rack rotating assembly 802 move to secure rack carrying assembly 600. In second configuration 1012, rack rotating assembly 800 and second rack rotating assembly 802 are actuated 850 so that securing elements 814 disposed on engagement tooling member 804 are inserted into securing apertures 622 on rack basket member 620. Once securing elements 814 have secured rack basket member 620, rack carrying assembly 600 is rotated in either first rotational direction 830 or second rotational direction 832 to properly orient article 10. As shown in third configuration 1014 article 10 is oriented with heel portion 120 in a downwards direction and is ready to proceed to the next processing station. In one embodiment, the next processing station after article 10 is rotated with heel portion 120 oriented downwards, is the dipping station which will execute a dip/dry cycle (i.e. Step 940) to color article 10.

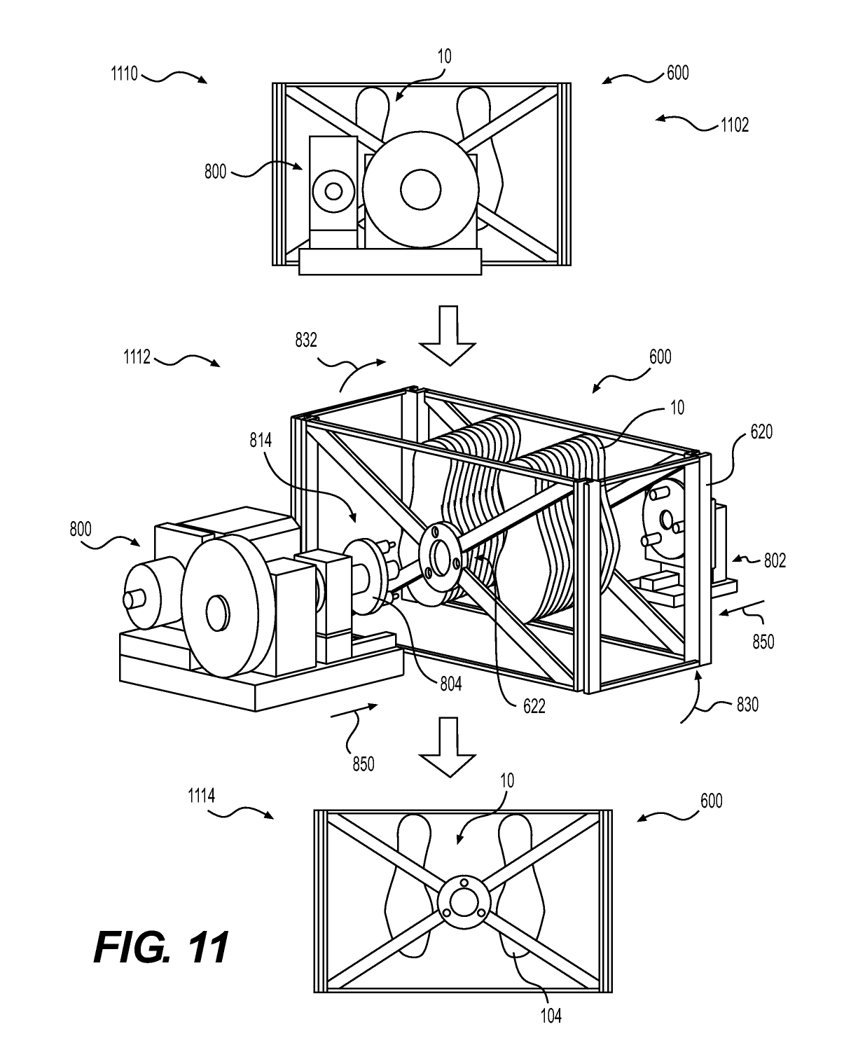

FIG. 11 illustrates another exemplary embodiment of a schematic sequential view of article 10 being rotated so that toe portion 104 is oriented for dipping. In some embodiments, article 10 may be rotated more than once as it undergoes dipping process 900. In some embodiments, it is desired to color article 10 with multiple colors. In some embodiments, article may have a first color along forefoot portion 100, a second color, different from the first color, along midfoot portion 110, and a third color, different from the first or second color, along heel portion 120. With the present embodiment, article 10 can be customized with multiple distinct colors along alternative target areas without mixing or overlap of colors but instead with a precise and accurate demarcation of the multiple distinct colors.

Referring to FIG. 11, for purposes of illustration, article 10 has already been dipped and colored with a first color in forefoot portion 100. After leaving a first dipping station, rack carrying assembly 602 with article 10 may proceed to a next processing station where article 10 may undergo a different action such as rinsing. After being rinsed, article may then proceed to next processing station 1102. In some embodiments, processing station 1102 is a rack rotation station. In first configuration 1110, as rack carrying assembly 600 is positioned at processing station 1102, rack rotating assembly 800 and second rack rotating assembly 802 move to secure rack carrying assembly 600. In second configuration 1112, rack rotating assembly 800 and second rack rotating assembly 802 are actuated 850 so that securing elements 814 disposed on engagement tooling member 804 are inserted into securing apertures 622 on rack basket member 620. Once securing elements 814 have secured rack basket member 620, rack carrying assembly 600 is rotated in either first rotational direction 830 or second rotational direction 832 to properly orient article 10. As shown in third configuration 1114, article 10 has toe portion 104 oriented in a downwards direction and is ready to proceed to the next processing station. In one embodiment, the next processing station after article 10 is rotated with toe portion 104 oriented downwards, is the dipping station which will execute a dip/dry cycle (i.e. Step 940) to color article 10 with a second color in toe portion 104.

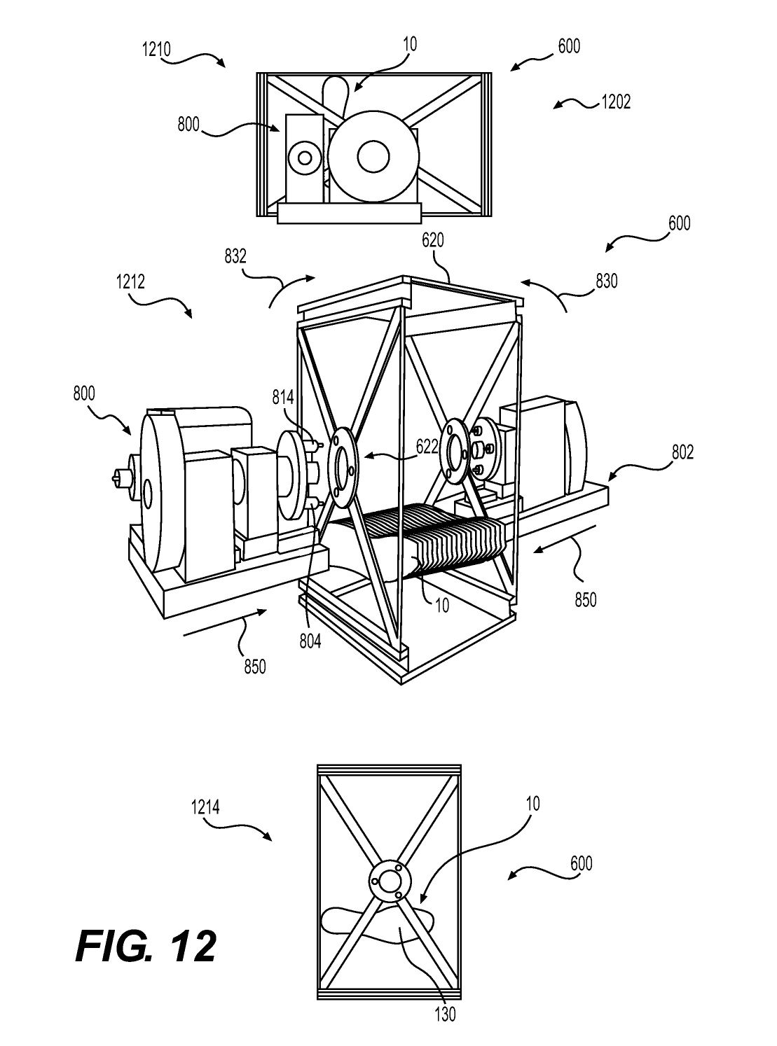

FIG. 12 illustrates another exemplary embodiment of a schematic sequential view of article 10 being rotated so that lateral side 130 is oriented for dipping. In some embodiments, article 10 may be loaded onto article carrying member 610 in a variety of configurations. In some embodiments, article 10 may be loaded onto article carrying member 610 along a lateral direction. In other words, the width of article 10 is oriented in a vertical direction. In some other embodiments, article 10 may be loaded onto article carrying member 610 so that the length of article 10 is oriented horizontally. In still some other embodiments, alternative configurations known in the art for loading article 10 onto article carrying member 610 may be utilized.

Referring to FIG. 12, in first configuration 1210, as rack carrying assembly 600 is positioned at processing station 1202, rack rotating assembly 800 and second rack rotating assembly 802 move to secure rack carrying assembly 600. In second configuration 1212, rack rotating assembly 800 and second rack rotating assembly 802 are actuated 850 so that securing elements 814 disposed on engagement tooling member 804 are inserted into securing apertures 622 on rack basket member 620. Once securing elements 814 have secured rack basket member 620, rack carrying assembly 600 is rotated in either first rotational direction 830 or second rotational direction 832 to properly orient article 10. As shown in third configuration 1214, article 10 has lateral side 130 oriented in a downwards direction and is ready to proceed to next processing station. In one embodiment, the next processing station after article 10 is rotated with lateral side 130 oriented downwards, is the dipping station which will execute a dip/dry cycle (i.e. Step 940) to color article 10.

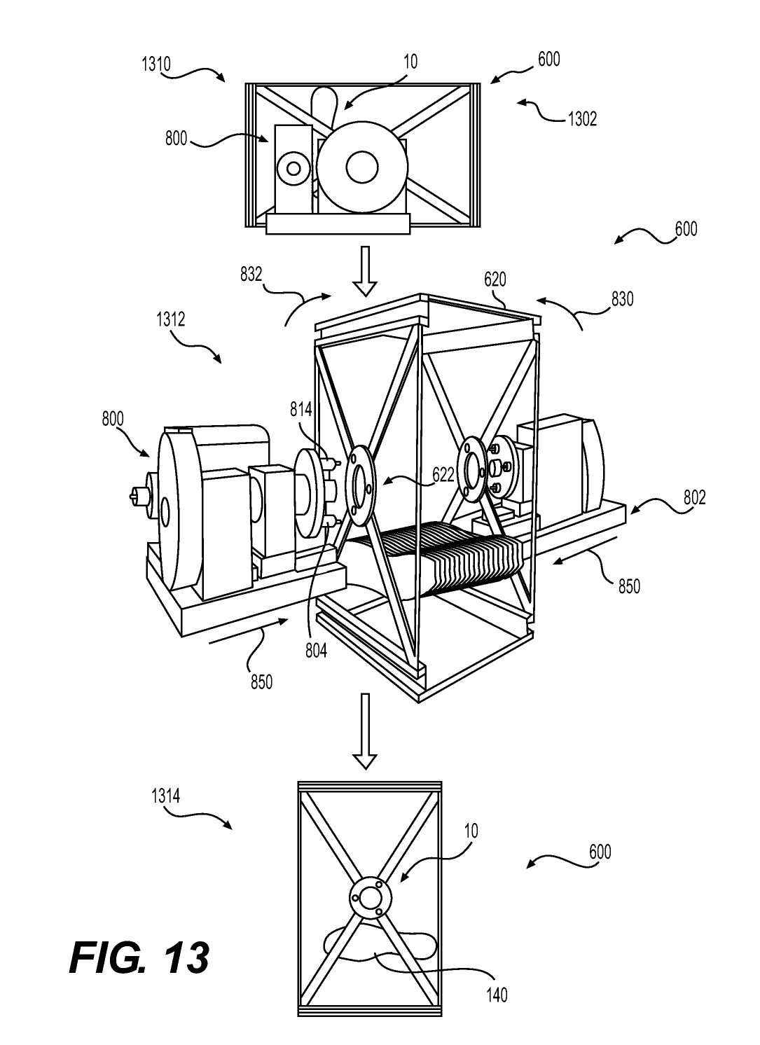

In a similar way, FIG. 13 illustrates another exemplary embodiment of a schematic sequential view of article 10 being rotated so that medial side 140 is oriented for dipping. In first configuration 1310, as rack carrying assembly 600 is positioned at processing station 1302, rack rotating assembly 800 and second rack rotating assembly 802 move to secure rack carrying assembly 600. In second configuration 1312, rack rotating assembly 800 and second rack rotating assembly are actuated 850 so that securing elements 814 disposed on engagement tooling member 804 are inserted into securing apertures 622 on rack basket member 620. Once securing elements 814 have secured rack basket member 620, rack carrying assembly 600 is rotated in either first rotational direction 830 or second rotational direction 832 to properly orient article 10. As shown in third configuration 1314, article 10 is rotated with medial side 140 oriented in a downwards direction and is ready to proceed to the next processing station. In one embodiment, the next processing station after article 10 is rotated with medial side 140 oriented downwards is the dipping station which will execute a dip/dry cycle (i.e. Step 940) to color article 10.

Some embodiments may have article 10 configured in alternative positions besides those illustrated in FIGS. 10 through 13. In some embodiments, article 10 may be secured and retained in rack carrying assembly 600 so that article 10 is oriented horizontally for immersions. In some embodiments, article 10 may be retained and oriented such that the target area may be along upper surface 150 for dipping. In another embodiment, article 10 may be retained and oriented such that the target area may be along lower surface 160. In some other embodiments, article 10 may be retained and oriented such that the target area may be along a combination of lower surface 160 and peripheral surface 170. In still some other embodiments, article 10 may be retained and oriented such that the target area may be along a combination of upper surface 150 and peripheral surface 170.

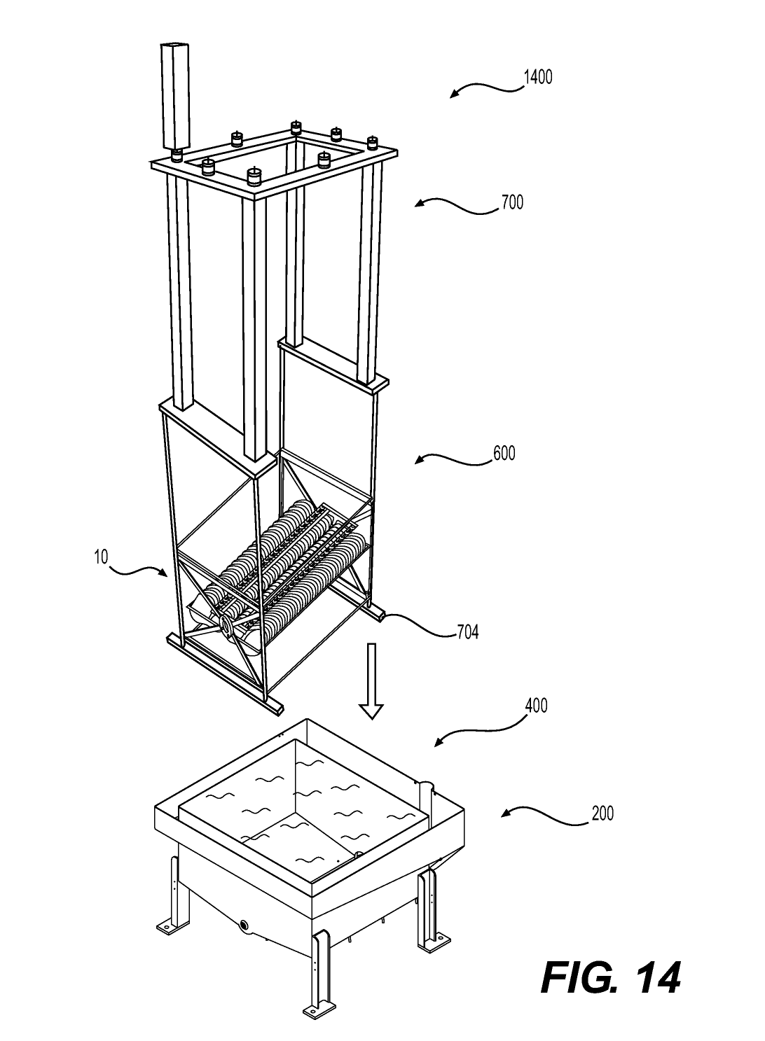

FIG. 14 illustrates an embodiment of processing station 1400 where article 10 is immersed in fluid container 200. In some embodiments, rack carrying assembly 600 may be conveyed or moved by means known in the art to processing station 1400. In some embodiments, prior to arriving at the processing station 1400, rack carrying assembly 600 may have been at a previous processing station such as a rack rotation station illustrated in FIGS. 10 through 13. In an exemplary embodiment, processing station 1400 is a dipping station where a dip/dry cycle is executed as described in Step 940 of FIG. 9. After rack carrying assembly 600 has been positioned on rack clamp 704 of actuator 700, rack carrying assembly 600, with article 10, is lowered into fluid container 200 with fluid 400.

In some embodiments, article 10 may be repeatedly lowered and raised into and out of fluid container 200. In some embodiments, article 10 may have as many as 30 immersions in order to achieve a pre-selected color saturation on portions of article 10 during dipping process 900. In some embodiments, as article 10 is raised out of fluid container 200 in a first immersion, the dye solution applied to the target area of article 10 may begin to cool and dry as described in the '735 application. In some embodiments, a second immersion of article 10 may take place within a certain period of time from the first immersion. In an exemplary embodiment, second immersion may be between or within 10 seconds and about 60 seconds of the first immersion (i.e. when article 10 is first lowered into fluid container 200). In some other embodiments, article 10 may have fewer immersions.

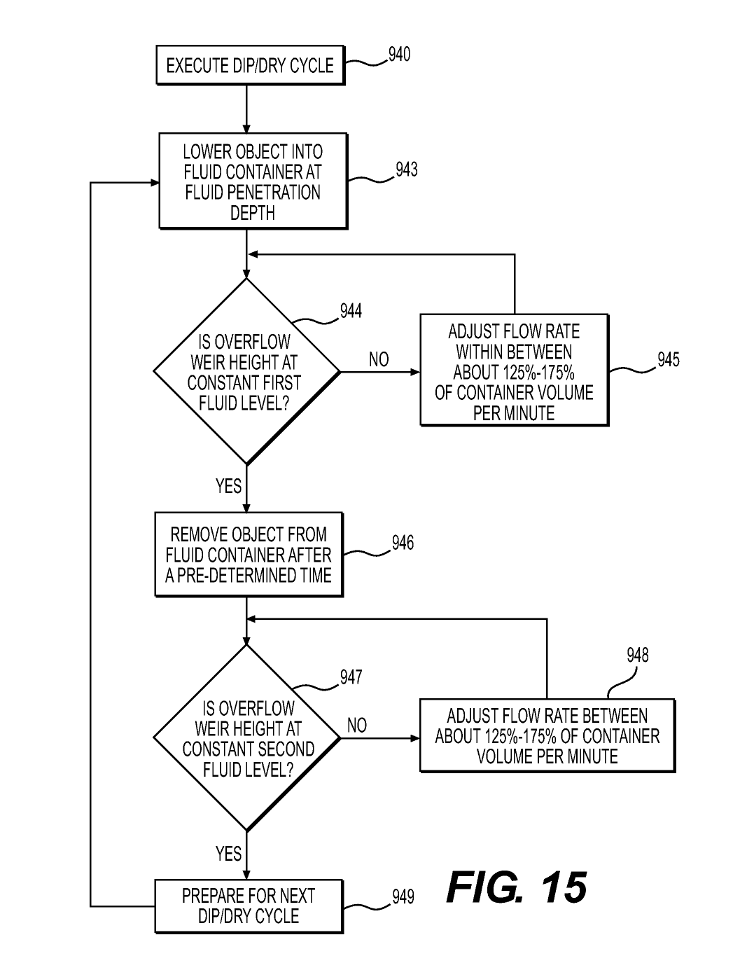

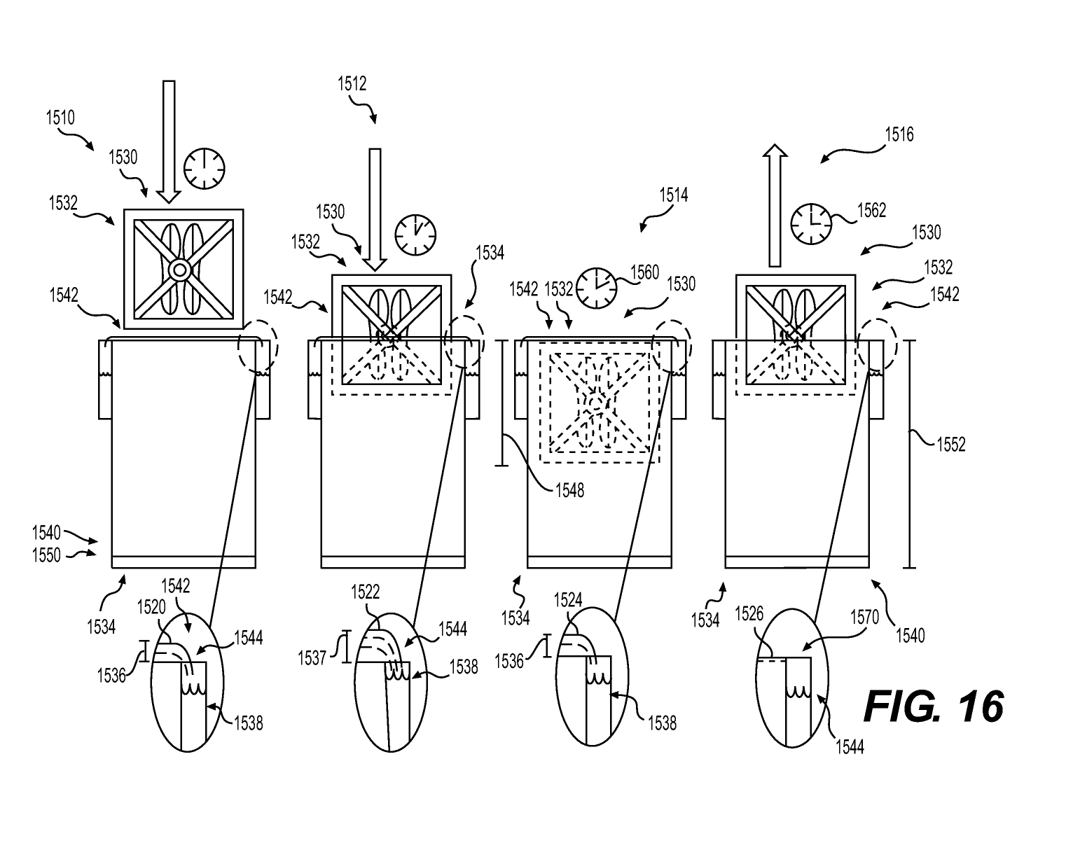

FIGS. 15 and 16 illustrate the dipping process where article 10, and rack carrying assembly 600, is dipped and then removed from fluid container 200 containing fluid 400 while maintaining a quiescent surface on fluid level 410. In particular, FIG. 15 expands on the specific process of executing the dip/dry cycle described in Step 940 of FIG. 9. Accordingly, it is understood that some or all of these steps occur prior to Step 950 of FIG. 9. Further it is to be understood that article 10, when dipped into fluid container 200, is secured on article carrying member 610 and loaded onto rack basket member 620.

In Step 943, article 10 is lowered into fluid container 200 and a target area is immersed in fluid 400 for a certain period of time. In some embodiments, the amount of time article 10 is immersed in fluid may depend on several factors. In some embodiments, factors may include the amount of saturation desired for article, or the size of a target area to be immersed, or a combination of other factors. As described in the '735 application, the length of time in which article 10 may remain in a dye solution may be short. In some embodiments, the immersion time may be within or between about 2 seconds to about 4 seconds. In an exemplary embodiment, the period article 10 is immersed in fluid 400 is between or within about 0.10 seconds to about 6 seconds. In some other embodiments, the period in which article 10 is immersed in fluid 400 may be greater.

In Step 944, dipping process 900, in particular sensor 530, will determine if fluid level 410 is at a constant first fluid level. The constant first fluid may be characterized as the fluid level height relative to the weir structure as objects are immersed. As previously mentioned, a specific fluid level is required for objects that are immersed to a desired fluid penetration depth of a dye solution.

During Step 944, if sensor 530 determines that the constant first fluid level is not at the correct level when article 10 is being immersed, then pump 510 may adjust flow rate 502 of fluid 400 from fluid reservoir container 500 to fluid container 200. In some embodiments, as article 10 is lowered into fluid container 200, rack volume 630 will displace a volume of fluid 400 resulting in an increase of fluid height 430 and accordingly, increase of overflow 420. In some embodiments, as article 10 is lowered, sensor 530 will measure the change in fluid level 410 caused by the displacement of the volume of fluid 400. In some embodiments, in order for article 10 to be dipped at the proper fluid penetration depth, fluid level 410 will need to be brought to the correct level or a first constant fluid level. In Step 945, pump 510 adjusts flow rate 502 until fluid level 410 is at the required fluid height 430 relative to weir structure 230 for the required fluid penetration depth of article 10. In one embodiment, flow rate 502 is adjusted to within or between about 125 percent and about 175 percent of a container volume per minute during immersion of objects.

It is to be appreciated that lowering article 10 into fluid container 200, and receiving overflow 420 into weir structure 230, while adjusting flow rate within or between about 125 percent and about 175 percent of a container volume per minute, reduces an amount of splashed fluid contacting the non-target areas. In other words, only the pre-determined target areas of article 10 will contact the fluid or dye solution. In contrast to other methods, for example, where a fluid container does not have a weir structure to receive any overflow when an object is immersed, and a flow rate is not adjusted, may result in splashed fluid contacting portions of an object that was not designated to be dyed during a dip/dry cycle.

After a period of time, once article 10 has been lowered into fluid container 200 with the target area at the proper fluid penetration depth, article 10 is removed from fluid container 200 in Step 946 to allow target area to dry. During Step 946, as article 10 is raised from fluid container 200, the displacement of fluid 400 again occurs due to the removal of rack carrying assembly 600.

In some embodiments, the raising of article 10 from fluid container will again change fluid height 430 and fluid level 410. As article 10 is removed, fluid level 410 is lowered due to the displacement of fluid 400. The lowering of fluid level 410 relative to weir structure 230, results in pump 510 adjusting flow rate 502 to place fluid level 410 at the proper fluid height 430. This fluid height 430 may be associated with a constant second fluid level of Step 947. Accordingly, as fluid level 410 changes, pump 510 may adjust flow rate 502 in Step 948 because fluid height 430 may be less than fluid container height 228. In one embodiment, flow rate 502 is adjusted to within or between about 125 percent and about 175 percent of a container volume per minute during the removal of article 10 with rack carrying assembly 600.

As mentioned previously, an article may be dipped repeatedly into the fluid container in a series of dip/dry cycles to color the article. In some embodiments, after achieving constant second fluid level in Steps 947 and 948, the next dip/dry cycle may be prepared for the same article. Therefore in Step 949, for articles undergoing repeated immersions, dipping process 900 will go back to Step 943 for the next immersion.

In some embodiments, prior to article 10 being dipped a second time, the constant second fluid level may be achieved within a certain period of time between the first immersion and the second immersion. Within that certain period of time between the first immersion and the second immersion, flow rate 502 may be adjusted by pump 510 to achieve the constant second fluid level. In one embodiment, the constant second fluid level of Step 947 may be achieved within about 5 percent to about 20 percent of the period time between the first immersion and the second immersion.

In some embodiments, after article 10 is dipped in fluid container 200 with dye solution and raised, dipping process 900 may pause article 10 for a period of time before immersing article 10 again in fluid container 200 with the same dye solution. In some embodiments, this period of time may be known as a “rest period” or “set period.” As used in this detailed description and in the claims, set period and its variants thereof, may be associated with the period of time between the end of removal of article 10 from fluid container 200 and the beginning of the next dip (i.e. when article 10 begins to be lowered). The set period may be used to refresh the dye concentration around the target area of article 10 thereby facilitating the coloring process. The set period may also be used to bring fluid level 410 to constant second fluid level. In an exemplary embodiment, dipping process 900 has a set period within a range of about 5 seconds to about 10 seconds. In some other embodiments, the set period between immersions may be longer. In still some other embodiments, the set period may be shorter.

In some embodiments, the amount of fluid or fluid volume returned to the fluid container during the set period may be associated with a refill rate. As used in this detailed description and in the claims, refill rate and its variants thereof may refer to the rate needed to return a volume of fluid to refill an empty fluid container per minute. In some embodiments, the refill rate may be between about 125 percent to about 325 percent of a volume of a fluid container per minute. For example, if the refill rate is 150 percent for achieving 100 percent of fluid container volume, one might expect that it may take 40 seconds to completely refill an empty fluid container. However, if the refill rate is 175 percent for achieving 100 percent of fluid container volume, one might expect that it may take 30 seconds to completely refill an empty fluid container. Still in some other embodiments, if the refill rate is 325 percent for achieving 100 percent of fluid container volume, one might expect that it may take 19 seconds to completely refill an empty fluid container. In one embodiment, refill rate 520 returns between about 10 percent to about 50 percent of fluid container volume 250 during the set period. In some other embodiment, refill rate 520 may return different percentages of volume of fluid 400 during the set period.

FIG. 16 illustrates a schematic sequential view of the execution of a dip/dry cycle where a quiescent surface of fluid is maintained. For clarity, the following detailed description discusses an exemplary embodiment, in which dipping process 900 immerses the whole article thereby coloring all of article's surfaces with a fluid (e.g. dye solution) during the dip/dry cycle. In other words, all surfaces of the article are target areas. In some other embodiments, depending on the target area, an article may only be partially immersed. For purposes of illustration, FIG. 16 shows various components of dipping process 900 in isolation from other components already described.

In first configuration 1510, rack carrying assembly 1532 with article 1530 is depicted being lowered into fluid container 1534 with fluid 1542. As seen in the enlarged view, fluid 1542 may be at first fluid level 1520 with overflow 1544. In some embodiments, first fluid level 1520 is maintained at fluid height 1536 relative to weir structure 1538. As explained earlier, flow rate 1550 of fluid 1542 from a fluid reservoir container may be used to maintain fluid height 1536. In some embodiments, the fluid reservoir container is configured to receive fluid 1542 from weir structure 1538 which captures overflow 1544. Flow rate 1550 recirculates fluid 1542 from the fluid reservoir container to interior lower portion 1540 of fluid container 1534 by means of a pump, as illustrated in FIG. 5.

In second configuration 1512, rack carrying assembly 1532 with article 1530 is lowered in fluid 1542 thus increasing the fluid height to second fluid height 1537. The increase to second fluid height 1537 causes first fluid level 1520 to rise to second fluid level 1522. Second fluid level 1522 is greater than first fluid level 1520 in first configuration 1510. The immersion of rack carrying assembly 1532 with article 1530 further causes overflow 1544 to increase into weir 1538. Simultaneously, the pump maintains flow rate 1550 of fluid 1542 from the fluid reservoir container to interior lower portion 1540 of fluid container 1534 to maintain a quiescent surface of fluid 1542 in fluid container 1534.

During third configuration 1514, article 1530 will be immersed at fluid penetration depth 1548 for period of time 1560 to dip/color article 1530. In some embodiments, as rack carrying assembly 1532 with article 1530 is being lowered, the fluid level in fluid container 1534 is maintained at a substantially horizontal level by the replenishment of fluid 1542 from the fluid reservoir container. As the pump maintains flow rate 1550, the fluid level is adjusted due to the volume of rack carrying assembly 1532 being introduced. The fluid level continues adjusting until article 1530 reaches fluid penetration depth 1548.

In some embodiments, as article 1530 is immersed in third configuration 1541 until reaching fluid penetration depth 1548, third fluid level 1524 may be substantially the same as first fluid level 1520 in first configuration. In other words, the fluid height 1536 at first fluid level 1520 and third fluid level 1524 may be the same. In some other embodiments, first fluid level 1520 may not be substantially the same as third fluid level 1524 because of a different fluid penetration depth 1548.

In some embodiments, article 1530 will remain buoyant when immersed into fluid container 1534 with fluid 1542. However, as discussed previously, article 1530, secured in an article carrying member 610 (illustrated in FIG. 6) will remain securely in place and not move while immersed into and out of fluid 1542 in fluid container 1534. Moreover, as article 1530 remains secured to article carrying member 610 during immersion, only those designated target areas for dyeing will be dyed and other portions not designated for dyeing will remain undyed.

In fourth configuration 1516, after period of time 1562, rack carrying assembly 1532 with article 1530 is raised from fluid container 1542. As shown in the enlarged view, as article 1530 is raised, overflow 1544 may decrease. Accordingly, fluid height 1570 in fourth configuration 1516 may be less than fluid container height 1552 thus changing the fluid level during third configuration 1514 from third fluid level 1524 to fourth fluid level 1526.

In some embodiments, as rack carrying assembly 1532 with article 1530 is raised, fluid 1542 is recirculated from the fluid reservoir container back into lower portion 1540 of fluid container 1534. Accordingly, the pump may adjust flow rate 1550 so that the fluid level remains at a substantially horizontal level to maintain a quiescent surface. Once rack carrying assembly 1532 with article 1530 is completely out of fluid container 1534, flow rate 1550 brings the level of fluid 1542 back to first fluid level 1520 of first configuration 1510.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

As used in the claims, the term “any of” is understood to mean any combination of one or more, and to thus include “any one of”.

What is claimed is:

1. A method for operating a fluid container to maintain a quiescent surface when an object is lowered into fluid in the fluid container, the fluid container having a container volume, a weir structure for maintaining a fluid level in the fluid container by allowing fluid to overflow the weir structure, and a lower portion, the method comprising the steps of:
urging fluid to flow from a reservoir container to the lower portion of the fluid container at a flow rate of between about 125 percent of the container volume per minute and about 175 percent of the container volume per minute; and
receiving overflow from the fluid container in the reservoir container.

2. The method of claim 1, further comprising at least partially immersing the object into the fluid container while maintaining the flow rate of between about 125 percent of the container volume per minute and about 175 percent of the container volume per minute.

3. The method of any of claims 1-2, further comprising achieving an essentially constant first fluid level above the weir structure in the fluid container when immersing the object into the fluid container.

4. The method of any of claims 1-3, further comprising achieving an essentially constant second fluid level above the weir structure in the fluid container when the object is immersed in the fluid container and when the object is fully removed from the fluid container.

5. The method of any of claims 1-4, further comprising pumping the flow from the reservoir to the fluid container.

6. The method of any of claims 1-5, further comprising again immersing the object.

7. The method of any of claims 1-6, wherein the second immersion is within between about 10 seconds and about 60 seconds of the first immersion.

8. The method of any of claims 1-7, wherein the essentially constant second fluid level is achieved within about 5-20 percent of the time between the second immersion and the first immersion.

9. The method of any of claims 1-8, further comprising measuring a height of the fluid flowing over the weir structure.

10. The method of any of claims 1-9, further comprising controlling the depth of the immersion of the object.

11. The method of any of claims 1-10, further comprising comparing the height of the fluid flowing over the weir structure to the second fluid level to control the depth of immersion of the object.

12. The method of any of claims 1-11, wherein the object has an object volume; and the object volume is up to about 8 percent of the container volume.

13. The method of any of claims 1-12, wherein a refill rate of the fluid container is between about 125 percent of the container volume per minute and about 325 percent of the container volume per minute.

14. The method of any of claims 1-13, wherein the container volume returned by the refill rate is between about 10 percent and about 50 percent of the container volume during a set period.

15. The method of any of claims 1-14, wherein the set period is within between about 5 seconds and 10 seconds.

16. The method of dyeing an object, comprising operating the fluid container of any of claims 1 to 15, wherein the fluid comprises a dye solution, and further comprising the steps of placing the fluid comprising the dye solution in the fluid container, lowering the object to be dyed at least partially into the fluid, maintaining the quiescent surface when the object to be dyed is lowered into the fluid comprising the dye solution in the fluid container, allowing dye from the fluid to contact and dye the object, producing a dyed object, and subsequently removing the dyed object from the fluid.

17. The method of dyeing of claim 16, wherein a first pre-determined portion of the object is to be dyed and a second predetermined portion of the object is to be left undyed, comprising lowering the object into the fluid to a pre-determined level, thereby dyeing the first predetermined portion of the object and leaving the majority of the second predetermined portion of the object undyed.

18. The method of dyeing of claim 17, wherein the method reduces the amount of splashed fluid which contacts the object within the second predetermined portion which is to be left undyed when the object is lowered into the fluid as compared to use of an identical method except using a fluid container without the weir structure, and without urging the fluid to flow from a reservoir container to the lower portion of the fluid container at a flow rate of between about 125 percent of the container volume per minute and about 175 percent of the container volume per minute.

19. The method of any of claims 1 to 18, wherein the object is buoyant in the fluid.

20. The method of any of claims 1 to 19, wherein the object is a fluid-filled bladder configured for use as a cushioning element of an article of footwear.
